(19) United States
(12) Patent Application Publication
(10) Pub. No.: US 2006/0072548 A1
(43) Pub. Date: Apr. 6, 2006

(54) User experience with residential voice gateways

(76) Inventors: Satish Kumar M. Mundra, Germantown, MD (US); Satyamurthy Yadavalli, Germantown, MD (US); Manoj Sindhwani, Oak Hill, VA (US)

Correspondence Address: TEXAS INSTRUMENTS INCORPORATED, P O BOX 655474, M/S 3999, DALLAS, TX, 75265, US

(21) Appl. No.: 10/954,893

(22) Filed: Sep. 30, 2004

(51) Int. Cl. H04L 12/66

(52) U.S. Cl. 370/352

(57) ABSTRACT

A method and system that enables IP (Internet Protocol)-like features on a conventional telephone that is connected to a device that handles voice calls on a network, such as a media gateway. The device sends messages concerning acknowledgement of call features, call status, call updates, and diagnostic or informative error information to the caller identification display on the conventional telephone.

### CROSS-REFERENCE TO RELATED APPLICATIONS

None.

### FIELD OF THE INVENTION

The present invention relates to improving a user experience with voice telephony gateway. More specifically, the present invention relates to making unconventional use of a conventional telephone Caller-ID display and signaling protocols for enhancing the user experience a voice over Internet Protocol (VoIP) gateway.

### BACKGROUND OF THE INVENTION

In typical telecommunications systems, voice calls and data are transmitted by carriers from one network to another network. Networks for transmitting voice calls include packet-switched networks transmitting calls using voice over Internet Protocols (VoIP), circuit-switched networks like the public switched telephone network (PSTN), asynchronous transfer mode (ATM) networks, etc. Recently, voice over packet (VOP) networks are becoming more widely deployed.

An example of networks and components for a VoIP call is illustrated in FIG. 1. A home access network comprises media gateway (MG) 12 connected to a network. An end user at a traditional analog wired phone 14 or cordless phone 16 can place voice calls through gateway 12 via an RJ11 telephony port on the gateway 12. MG 12 uses VoIP for transmitting and receiving voice calls and is connected to broadband network 18 that may include the Internet. Access to the Internet from MG may be provided via cable modem, DSL (digital subscriber line) modem, high speed fiber network, frame relay access network, Internet backbone, etc.

A media gateway for residential and commercial applications is a bearer of network traffic and signaling interworking between the PSTN and VoIP. The media gateway also provides the service of mapping and translating functions and protocols between VoIP and traditional/conventional telephony devices, such as analog phone 16. Services performed by MG 12 include voice compression, tone generation, tone detection, delay and jitter compensation, PLC, signaling mapping for PSTN subscriber signaling and VoIP signaling, echo cancellation, and packet media termination for packets coming from broadband network 18 since packets are not used in the analog side of the MG. MG 12 reverses its operations for voice signals originating in analog equipment; it takes analog signals from a subscriber telephone, converts them to packets, and transmits the packets across IP network 18.

A signaling component in MG 12 translates between VoIP signaling and PSTN signaling to provide a mechanism to transport endband signaling, such as tones, over a packet network in a reliable fashion. A media gateway controller is the controlling operator for the MG and signaling gateway, responsible for processing protocol messages, security and user authentication, and monitoring processing resources.

A voice call may be placed between analog phone 16 to remote analog phone 20 through the PSTN 28 and central office 30. PSTN is also connected to IP network 18 through a trunk gateway system that has components signal gateway 24, media gateway controller/proxy (MGC) 22, and trunk media gateway (MG) 26. IP and packet data (e.g., real time protocol) associated with the call is routed between RGW 12 and trunk MG 26. The trunk gateway system provides real-time two-way communications interfaces between the IP network 18 and the PSTN 28.

VoIP telephony is being deployed in enterprises and homes to reduce the cost of a telephone system and service and to improve the capabilities of a phone system. Improving the user experience and enabling new features and class of applications with VoIP systems were not possible with traditional circuit-switched PSTN telephony systems. The enterprise deployment of VoIP phone systems typically involves an IP PBX (Internet Protocol Private Branch Exchange) comprising IP phones, which have a large display screen and keypad with many function keys. These IP phones provide a user with ease-of-use of traditional features and the ability to add a new class of applications and new features that were not available with traditional analog telephones.

However for home users, the experience of using VoIP service has been limited as compared to services and features currently available from a traditional analog phone. The limitation is primarily due to the standard RJ11 2-wire analog interface to which only analog phones or cordless base stations with which 2-wire RJ-11 connections can be attached.

### SUMMARY OF THE INVENTION

The present invention describes a technique that uses a Caller-ID display and associated Caller-ID protocols in order to enhance the user experience with a conventional subscriber telephone that are attached to a media gateway using voice protocols such as voice over Internet Protocol. Thus, the present invention provides an IP Phone-like experience for a subscriber using a conventional telephone, such as an analog phone. Like using a full VoIP telephone, a user will be able to use a conventional phone combined with a VoIP gateway to read diagnostic messages, receive call state updates, status, use call features, and perform basic configuration/management action.

### BRIEF DESCRIPTION OF THE DRAWINGS

For a better understanding of the nature of the present invention, its features and advantages, the subsequent detailed description is presented in connection with accompanying drawings in which:

FIG. 1 is a network diagram of a Voice Over IP network;

FIG. 2 is a diagram of an exemplary analog phone with a caller-ID text enabled;

FIG. 3 is a flowchart of the preferred method for using a Caller-ID signal from a residential gateway;

FIG. 4 is a flowchart of using a Caller-ID signal to notify a user of informative/diagnostic messages;

FIG. 5 is a flowchart of using a Caller-ID signal to notify a user of an activated call feature;

FIG. 6 is a flowchart of using a Caller-ID signal to notify a user of a call state or event update.

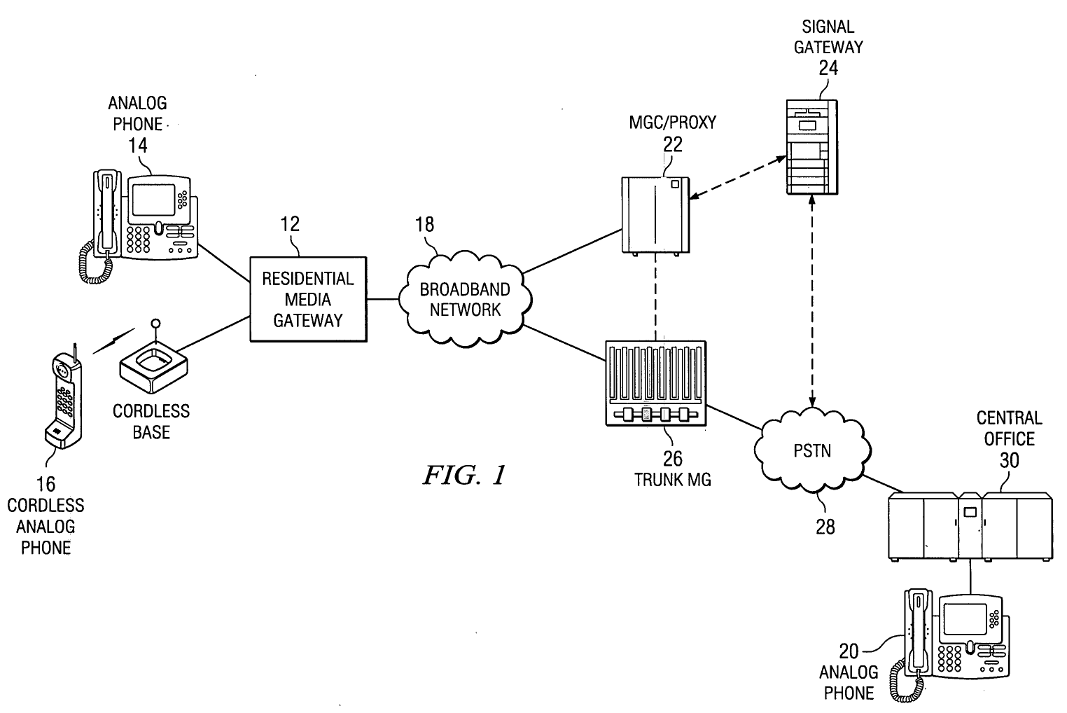

### DETAILED DESCRIPTION OF PREFERRED EXEMPLARY EMBODIMENTS

The preferred embodiment of the present invention includes a technique and system for using the Caller-ID (Identification) display on conventional telephones that are connected to a media gateway for transmitting voice data over a network, such as a broadband packet network using Internet Protocol (IP). Instead of conventionally displaying only Caller-ID information in a Caller-ID display, the Caller-ID of a telephone can preferably display messages sent by a media gateway in an on-hook or off-hook state for other useful purposes. The present invention does not impose any special requirement on an conventional phone. It is understood that the present invention is not limited to the use of analog phones; rather, the present invention will work with any phone that has Caller-ID capabilities.

Caller-ID signaling protocol and the message format for North America is specified in Bellcore (Telcordia) specification GR-30-Core and GR-1188-Core. There are others variants of the Caller-ID specified by ETSI, British Telecom, China Telecom, and NTT with some changes to either signaling or message format. The basic principle, however, is same. It involves an alerting signal, an acknowledgement of the alert signal (typically when the phone is in off-hook state), and then transmission of the message. The preferred embodiment can support multiple such standards and is independent of these variants.

A Caller-ID signal is generated as follows. When an incoming call is received the media gateway (MG) generates a Caller-ID by extracting the caller name and number information from the incoming signaling protocol message and then sends the information to a Caller-ID display as per the selected protocol. The phone then displays the incoming message on the Caller-ID display. In case the phone is off-hook, the phone also mutes the voice path towards the handset when it receives the alert signal, which is typically a tone of duration of 100 ms (milliseconds) or less.

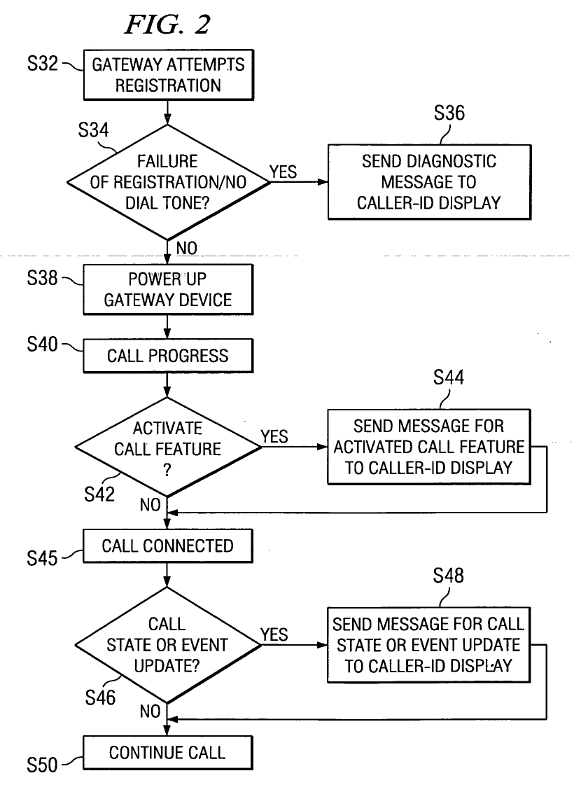

Referring to the flowchart of FIG. 2, a VoIP MG 12 powers up and attempts communication S32 with servers on Broadband IP network 18. Servers include a provisioning server, Call server such as a SIP (Session Initiation Protocol) Proxy or MGCP (Media Gateway Control Protocol)/Megaco Call Agent. Only upon successful provisioning and registration S34 does the MG 12 provide dial tone to a user. If the attempt to register fails S34 and no dial tone is heard on the phone, a user typically does not know the cause and nature of failure for the missing dial tone. Some gateways provide voice announcements that are stored on a flash on the gateway, which increases the cost of such devices. Failure condition can also occur at times other than startup and are certainly not limited to the limited number of announcement messages stored in the flash.

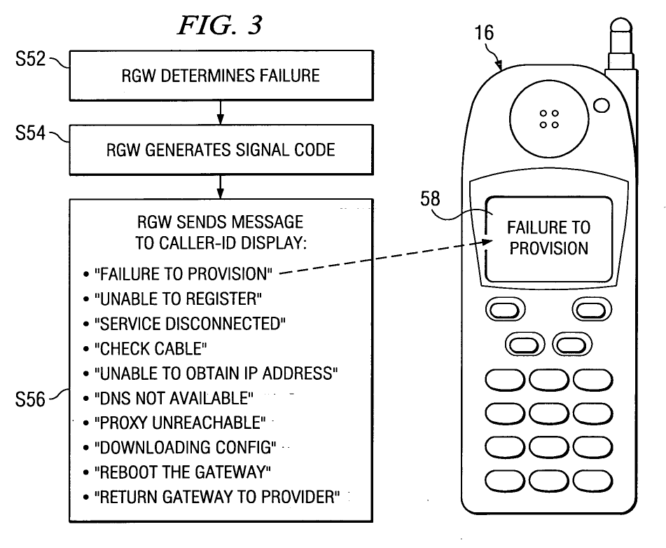

When the registration fails a diagnostic message generated using the Caller-ID signal and is displayed S36 on the Caller-ID of the conventional (e.g., analog) phone 16 instead of the conventional Caller-ID data. When a user is ready to place a call on a phone 18, her first act is to remove the phone from a cradle, placing the phone in an off-hook status, and check for a dial tone S38. Referring to FIG. 3, an exact cause of failure and/or missing dial tone can be determined by MG 12 S52. MG 12 generates a signal containing an informative/diagnostic message S54 that is sent S56 to display as a message on the phone's Caller-ID display 58. The user can then read the diagnostic message and determine a reason for failure. Sample exemplary messages S56 that can be displayed on a Caller-ID screen 58 include the following messages:
“Failure to Provision”
“Unable to Register”
“Service Disconnected”
“Check Cable”
“Unable to Obtain IP Address”
“DNS not Available”
“Proxy Unreachable”
“Downloading Config”
“Reboot the Device”
“Return Device to Provider”

The Caller-ID display on an conventional phone can preferably display messages when a user enacts a telephony service feature. An IP Phone or business phone has function keys such as “Transfer” “Forward”, and “Conference” or enables the use of such feature in conjunction with a display. Access to such features on conventional phones is typically via feature codes such as “*xx,” where “xx” are two digit codes or other events/actions such as flash-hook. The confirmation is via confirmation tone or distinctive dial tone, which confirms that a valid code was dialed. Note that this confirmation only indicates that a valid feature code has been dialed. For the conventional phone, there is no visual means to indicate if the desired feature has actually been activated, and a user must simply assume that he or she dialed the correct code for the desired feature.

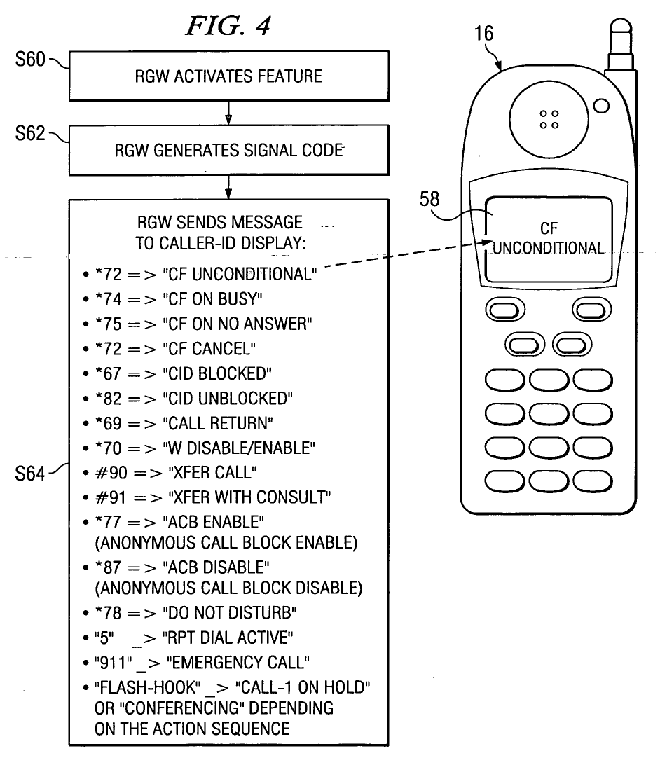

If the call is properly registered and progresses to dial tone and placing a call S40, the user's experience with notifications of enacted features can be enhanced as follows. Conventional confirmation tones or the distinctive dial tones are continued to be provided on a conventional phone. However, phone 16 will preferably confirm the user action or feature activation S42 on the Caller-ID display S44. Referring to FIG. 4, when a user enacts a feature on phone 16, the MG 12 will enact the feature S60 and generate an acknowledgement signal S62. MG 12 then sends acknowledgement message S64 to phone 16 to display on Caller-ID display 58. A user may confirm that not only she dialed a valid code but also confirm that the desired feature was activated. For example, the Caller-ID display 58 will show one of the following sample exemplary messages S64 upon various user actions. In sample codes are designated as *xx, which defines the “*” key on a keypad and two numbers. For example *67 enacts the feature of blocking Caller-ID.
*72=>“CF Unconditional”
*74=>“CF on Busy”
*75=>“CF on No Answer”
*72=>“CF Cancel”
*67=>“CID Blocked”
*69=>“Call Return”
*82=>“CID Unblocked”
*70=>“W Disable/Enable”
#90=>“Xfer Call”
#91=>“Xfer with Consult”
*77=>“ACB Enable” (Anonymous Call Block Enable)
*87=>“ACB Disable” (Anonymous Call Block Disable)
*78=>“Do Not Disturb”
“5”=>“RPT Dial Active”
“911”=>“Emergency Call”
“flash-hook”=>“Call-1 on Hold” or “Conferencing” depending on the action sequence

Following the flowchart of FIG. 2, after the call is connected S45, MG 12 can preferably utilize the Caller-ID display of a conventional phone to pass call state or event updates S46 that are available from IP network 18 via notifications or call signaling to a Caller ID display S48. Using signaling protocols that provide distributed call control such as SIP, a media gateway is actively involved in all stages of call processing, whether for a single-party or for a multi-party call. MG 12 remains aware of call state at all the times. In case of 3PCC (3rd party call control) in SIP or protocols such as MGCP/Megaco, the call control is performed by the network 18, and the MG 12 may not be aware of call state the time. Event packages typically update the MG 12 of call state in case of 3PCC or when services of network elements are accessed. Such features and packages are defined in view of using IP Phones with advanced displays and notifications, which will update the user with call state changes as determined by the signaling messages or notification received from network elements.

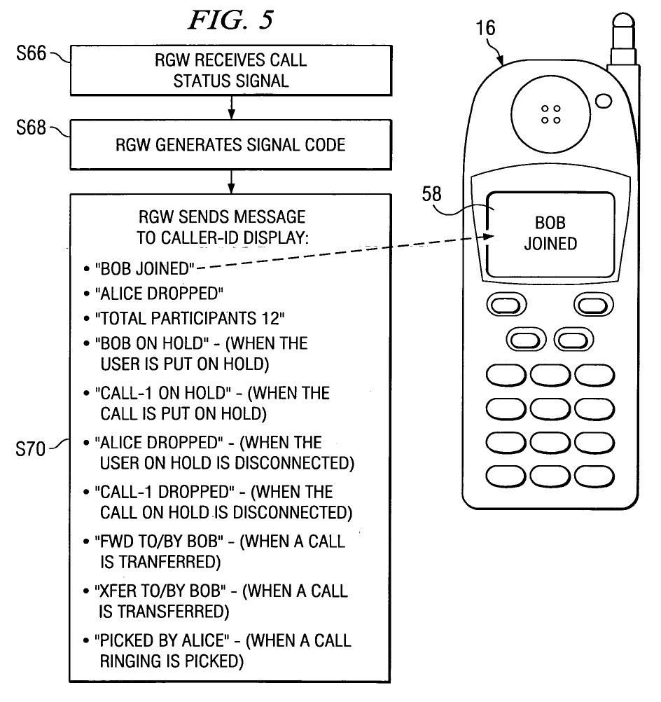

Referring to FIG. 5, MG 12 receives call state or event updates signals S66, generates a message from the signal S68, and sends the message S70 to update the user via a message on a Caller-ID display 58. During a conference call, the following sample exemplary messages could be sent from MG 12 to the Caller-ID:
“Bob Joined”,
“Alice Dropped”
“Total participants 12”

If a user enacts call waiting service, in the call waiting scenario, MG 12 could update S70 the user's Caller-ID 58 with sample messages as follows:
“Bob on Hold” (When the user is put on hold)
“Call-1 on Hold” (When the call is put on hold)
“Alice Dropped” (When the user on hold is disconnected)
“Call-1 Dropped” (When the call on hold is disconnected)

If a user enacts any one of a call forward, transfer, or pickup service, MG 12 could update the user's Caller-ID display 58 with one of the following sample messages as follows:
“FWD to/by Bob” (When a call is transferred)
“XFER to/by Bob” (When a call is transferred)
“Picked by Alice” (When a call ringing is picked)

The preferred use of Caller-ID displays can use the SDP/SIP-Invite to offer descriptions about the type of call that the user is receiving so that the user can perform further actions regarding the call. For example, different types of calls can include an incoming facsimile, an incoming modem call, or a TTY (text) call. Upon reception of a call, MG 12 could send one of the following sample messages to the Caller-ID display:
“FAX Call”
“Modem Call” or “Data Call”
“TTY Call” or “Text Call”

The Caller-ID display 58 may also be used for text messaging from an incoming TTY/text call, and a user could use a conventional speech-to-text conversion service for enabling TTY capability to complete the service.

In an alterative embodiment, the message format such as MDMF (Multiple Data Message Format) is enhanced with proprietary message types so that the conventional message types do not overload the user's display. The messages described in the preferred embodiment herein are handled by a phone as if the messages were accompanying incoming calls and will be recorded as such. This process can clutter the memorized Caller-ID list on a phone, which commonly requires manual deletion of messages. By defining new message types, a desired treatment for the messages can be achieved, such as configurable automatic deletion of the messages. However, such customized messaging could compromise universal interoperability that the present invention provides.

Using the preferred MG and a Cordless Phone 16 in a residential environment, a home telephone can behave as a business IP Phone. The interface between a home telephone's base station module and a VoIP gateway module need not be limited to conventional 2-wire interfaces.

Using the preferred methods, users' experiences are enriched while interfacing with Caller-ID capable phones that are connected to VoIP gateways. Incorporation of these features into a media gateway will offer an alternative to stored announcement messages on the flash that is provided by means of visual indication. This will result in the advantages of offering IP Phone-like experience with an analog phone with call state updates and notifications from a network. Users will experience cost reduction, preservation of existing investments in conventional cordless phones, ease of use with when supplementary call features are enacted, reduced support cost with accurate diagnostic/failure information on the display, and improved satisfaction with VoIP telephony in the residential or office environment.

One skilled in the art will appreciate that the present invention can be practiced by other than the described embodiments, which are presented for purposes of illustration and not limitation, and the present invention is limited only by the claims that follow.

1. A method for transmitting messages from a network device to a telephone, comprising:
connecting a conventional telephone, comprising a caller identification (Caller-ID) display, to a network device;
connecting said network device to a network;
generating a Caller-ID signal containing a non-Caller-ID message;
transmitting said signal, using Caller-ID protocols, to said telephone; and
displaying said message on said Caller-ID display.

2. The method of claim 1, further comprising:
registering said gateway with an application server on said network when a call is attempted on said telephone; and
transmitting, using said caller-ID signal, a message gateway to said caller-ID display regarding the status of said registration.

3. The method of claim 1, wherein said connecting said conventional telephone comprises connecting an analog telephone.

4. The method of claim 1, wherein said generating said signal comprises generating an acknowledgement signal after activation of a telephony service feature, and
said displaying comprises displaying a message corresponding to said telephony service activation.

5. The methods of claim 1, wherein said generating said signal comprises generating a signal for an event update during a third party call, and
said displaying comprises displaying a message corresponding to said event update.

6. The method of claim 1, wherein said generating said signal comprises generating a signal for a call status after activation of a telephony service, and
said displaying comprises displaying a message corresponding to said call status.

7. The method of claim 1, wherein said displaying comprises displaying a description of a type of incoming call to said telephone.

8. The method of claim 1, wherein said connecting comprises connecting a conventional telephone to a media gateway on said network.

9. A system, comprising:
a voice over packet transmission device connected to a network;
a conventional telephone, connected to said device, comprising a caller identification (Caller-ID) display,
wherein said device generates caller-ID signal containing a non-caller-ID message and transmits said message for display on said Caller-ID display.

10. The system of claim 9, further comprising:
an application server connected to said network, wherein said device attempts a registration on said server after powering-up, and
said device transmits a message, using said caller-ID signal, to said caller-ID display regarding the status of the registration.

11. The system of claim 9, wherein said conventional telephone is an analog telephone connected to said device.

12. The system of claim 9, wherein said voice over packet device is a media gateway connected to said network.

13. The system of claim 9, wherein said device sends an acknowledgement message, using said caller-ID signal, to said telephone after activation of a telephony service feature, and
said Caller-ID display displays said acknowledgement message in said caller-ID signal.

14. The system of claim 9, wherein said device sends an event update message, using said caller-ID signal, to said telephone, and
said Caller-ID said displays said update message in said caller-ID signal.

15. The system of claim 9, wherein said device sends a call status message to said telephone when a telephony service is activated, and
said Caller-ID display displays said call status message.
